(19) United States
(12) Patent Application Publication
(10) Pub. No.: US 2019/0238891 A1
(43) Pub. Date: Aug. 1, 2019

(54) METHOD OF PROCESSING IMAGES AND ELECTRONIC DEVICE THEREOF

(71) Applicant: Samsung Electronics Co., Ltd., Suwon-si (KR)

(72) Inventors: Chan Heo, Suwon-si (KR); Kyung-mok Kum, Suwon-si (KR); Jong-kwon Park, Suwon-si (KR); Rakie Kim, Suwon-si (KR)

(73) Assignee: Samsung Electronics Co., Ltd., Suwon-si (KR)

(21) Appl. No.: 16/257,219

(22) Filed: Jan. 25, 2019

(30) Foreign Application Priority Data
Feb. 1, 2018 (KR) 10-2018-0012867

(51) Int. Cl. H04N 19/86; H04N 19/423; G06F 12/02

(52) U.S. Cl. CPC H04N 19/86; G06F 12/0223; H04N 19/423

(57) ABSTRACT

Provided are a method of processing images and an electronic device thereof. The electronic device includes a memory and a processor operatively connected to the memory. The processor is configured to divide an image into a plurality of sub images, load information about a first sub image of the plurality of sub images into the memory, perform image processing on the first sub image, load information about an image area that does not overlap with the first sub image of a second sub image located in a longitudinal direction of the first sub image into the memory, and perform image processing on the second sub image.

### CROSS-REFERENCE TO RELATED APPLICATION

This application claims the benefit of Korean Patent Application No. 10-2018-0012867, filed on Feb. 1, 2018, in the Korean Intellectual Property Office, the disclosure of which is incorporated herein in its entirety by reference.

### BACKGROUND

The inventive concepts relate to a method of processing images and an electronic device thereof.

With the development of information technology, electronic devices are evolving into multimedia devices that handle various multimedia functions. For example, the electronic devices may provide various multimedia services such as a broadcasting service, a wireless Internet service, and a music service.

The amount of multimedia data that electronic devices have to handle according to the needs of users who demand better quality multimedia functions has increased. Accordingly, technologies for rapidly processing large amounts of multimedia data in the electronic devices have been developed, and technologies for improving the speed of image processing techniques such as image recognition or image processing have been developed in particular.

### SUMMARY

An electronic device may extract features from images by using various image filters to process image data, such as image recognition or image processing. Such an image filter may use information about a peripheral area of a certain size in addition to a designated area for processing images. Accordingly, when an image is processed by a tile-based image processing method that performs image filtering by dividing an image into a plurality of sub images, the electronic device superimposes and loads information about the peripheral area of a certain size in a memory. When the size of the superimposed peripheral area of a certain size is increased or the number of image tiles is increased, the amount of information for the superimposed peripheral area of a certain size is increased, and a memory load is increased. As a result, an image processing time may increase and/or power consumption may also increase.

Various embodiments of the inventive concepts provide a method and a device for reducing image processing time for image filtering and/or power consumption according to image processing by reusing overlapping image areas in consecutive sub images when performing image processing by dividing an image into a plurality of sub images.

According to an aspect of the inventive concepts, there is provided an electronic device including: a memory; and a processor operatively connected to the memory, wherein the processor is configured to: divide an image into a plurality of sub images; load information about a first sub image of the plurality of sub images into the memory; perform image processing on the first sub image; load information about an image area that does not overlap with the first sub image of a second sub image located in a longitudinal direction of the first sub image into the memory; and perform image processing on the second sub image.

According to another aspect of the inventive concepts, there is provided an electronic device including: a memory; and a processor operatively connected to the memory, wherein the processor is configured to: divide an image into a plurality of sub images; load information about a first sub image of the plurality of sub images into the memory; load information about an image area that does not overlap with the first sub image of a second sub image located in a horizontal direction of the first sub image into the memory; and perform image processing on the second sub image.

According to another aspect of the inventive concepts, there is provided an electronic device including: a memory; and a processor operatively connected to the memory, wherein the processor is configured to: divide an image into a plurality of sub images; load information about a first sub image of the plurality of sub images into the memory; perform image processing on the first sub image; load information about an image area that does not overlap with a second sub image of the second sub image located in a longitudinal direction of the first sub image into the memory; perform image processing on the second sub image; load information about an image area that does not overlap with the first sub image of a third sub image located in a horizontal direction of the first sub image into the memory; perform image processing on the third sub image; load information about an image area that does not overlap with adjacent sub images of a fourth sub image located in a horizontal direction of the second sub image into the memory; and performing image processing on the fourth sub image.

### BRIEF DESCRIPTION OF THE DRAWINGS

Embodiments of the inventive concepts will be more clearly understood from the following detailed description taken in conjunction with the accompanying drawings in which:

FIG. 1 is a block diagram of an electronic device in a network environment according to various embodiments;

FIG. 2 is a flowchart for explaining an example of a method of processing images in an electronic device according to various embodiments;

FIGS. 3A to 3D are views for explaining an example of a method of processing images in an electronic device according to various embodiments;

FIG. 4 is a flowchart for explaining an example of a method of processing images in an electronic device according to various embodiments;

FIGS. 5A to 5D are views for explaining an example of a method of processing an image in an electronic device according to various embodiments;

FIG. 6 is a flowchart for explaining an example of a method of processing images in an electronic device according to various embodiments; and

FIGS. 7A to 7D are views for explaining an example of a method of processing images in an electronic device according to various embodiments.

### DETAILED DESCRIPTION OF EMBODIMENTS

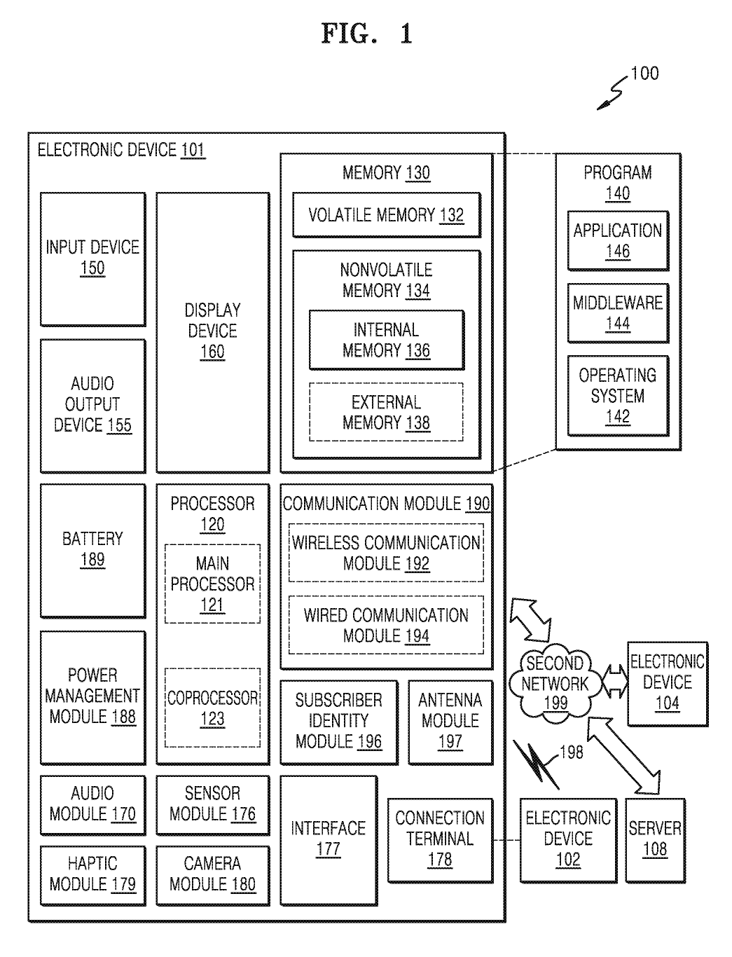

FIG. 1 is a block diagram of an electronic device 101 in a network environment 100 according to various embodiments.

Referring to FIG. 1, the electronic device 101 in the network environment 100 may communicate with an electronic device 102 via a first network 198 (e.g., near-field communication) or may communicate with an electronic device 104 or a server 108 via a second network 199 (e.g., far-field communication). According to an embodiment, the electronic device 101 may communicate with the electronic device 104 via the server 108. According to an embodiment, the electronic device 101 may include a processor 120, a memory 130, an input device 150, an audio output device 155, a display device 160, an audio module 170, a sensor module 176, an interface 177, a haptic module 179, a camera module 180, a power management module 188, a battery 189, a communication module 190, a subscriber identity module 196, and/or an antenna module 197. In some embodiments, at least one (e.g., the display device 160 or the camera module 180) of these components may be omitted or other components may be added to the electronic device 101. In some embodiments, some components, such as, for example, the sensor module 176 (e.g., a fingerprint sensor, an iris sensor, or an illuminance sensor) embedded in the display device 160 may be integrated.

The processor 120 may control at least one of other components (e.g., hardware or software components) of the electronic device 101 that is connected to the processor 120 by driving software (e.g., a program 140), and may perform various data processing and arithmetic operations. The processor 120 may load and process commands or data received from other components (e.g., the sensor module 176 or the communication module 190) into a volatile memory 132 and store resulting data in a nonvolatile memory 134. According to an embodiment, the processor 120 may include a main processor 121 (e.g., a central processing unit or an application processor) and a coprocessor 123 (e.g., a graphics processing unit, an image signal processor, a sensor hub processor, and/or a communications processor) that is operated independently of the main processor 121 and additionally or alternatively uses less power than the main processor 121, or is specialized for a specified function. According to an embodiment, the coprocessor 123 may be operated separately or embedded with the main processor 121.

In such a case, the coprocessor 123, for example, may control at least some of functions or states associated with at least one of components of the electronic device 101 instead of the main processor 121 while the main processor 121 is in an inactive (e.g., sleep) state, or together with the main processor 121 while the main processor 121 is in an active (e.g., application execution) state. According to an embodiment, the coprocessor 123 (e.g., an image signal processor or a communication processor) may be implemented as one of other functionally related components (e.g., the camera module 180 or the communication module 190). The memory 130 may store various data used by at least one component (e.g., the processor 120 or the sensor module 176) of the electronic device 101, such as software (e.g., the program 140) and input data or output data for a command related to the software. The memory 130 may include the volatile memory 132 or the nonvolatile memory 134.

The program 140 may be software stored in the memory 130 and may include, for example, an operating system 142, middleware 144, and/or an application 146.

The input device 150 is a device for receiving commands or data to be used in a component (e.g., the processor 120) of the electronic device 101 from the outside (e.g., a user) of the electronic device 101, and may include, for example, a microphone, a mouse, and/or a keyboard.

The audio output device 155 is a device for outputting an audio signal to the outside of the electronic device 101 and may include, for example, a speaker for general use such as multimedia reproduction or recording reproduction and a receiver for telephone reception only. According to an embodiment, the receiver may be formed integrally with the speaker or separately.

The display device 160 is a device for visually providing information to a user of the electronic device 101 and may include, for example, a display, a hologram device, and/or a control circuit for controlling a projector and a corresponding device. According to an embodiment, the display device 160 may include a pressure sensor capable of measuring the intensity of pressure on touch circuitry or touch.

The audio module 170 may bidirectionally convert sound and electrical signals. According to an embodiment, the audio module 170 may obtain sound through the input device 150, or may output sound through the audio output device 155 or an external electronic device (e.g., the electronic device 102 (e.g., a speaker or a headphone) connected to the electronic device 101 in a wired or wireless manner.

The sensor module 176 may generate an electrical signal or a data value corresponding to an internal operating state (e.g., power or temperature) of the electronic device 101 or an external environmental condition. The sensor module 176 may be, for example, a gesture sensor, a gyro sensor, a barometric sensor, a magnetic sensor, an acceleration sensor, a grip sensor, a proximity sensor, a color sensor, an infrared (IR) sensor, a biological sensor, a temperature sensor, a humidity sensor, and/or an illuminance sensor.

The interface 177 may support a specified protocol that may be connected to an external electronic device (e.g., the electronic device 102) in a wired or wireless manner. According to an embodiment, the interface 177 may include a high definition multimedia interface (HDMI), a universal serial bus (USB) interface, a secure digital (SD) card interface, and/or an audio interface.

A connection terminal 178 may include a connector, for example, an HDMI connector, a USB connector, an SD card connector, and/or an audio connector (e.g., a headphone connector) capable of physically connecting the electronic device 101 to an external electronic device (e.g., the electronic device 102).

The haptic module 179 may convert an electrical signal into a mechanical stimulus (e.g., vibrations or movements) or an electrical stimulus that a user may perceive through a tactile or kinesthetic sense. The haptic module 179 may include, for example, a motor, a piezoelectric device, and/or an electrical stimulation device.

The camera module 180 may capture a still image and a moving image. According to an embodiment, the camera module 180 may include one or more lenses, image sensors, image signal processors, and/or flashlights.

The power management module 188 is a module for managing power supplied to the electronic device 101 and may be configured as at least a portion of, for example, a power management integrated circuit (PMIC).

The battery 189 is a device for supplying power to at least one component of the electronic device 101 and may include, for example, a non-rechargeable primary battery, a rechargeable secondary battery, and/or a fuel cell.

The communication module 190 may support establishment of a wired or wireless communication channel between the electronic device 101 and the external electronic device (e.g., the electronic device 102, the electronic device 104, and/or the server 108), and communication through the established communication channel. The communication module 190 may include one or more communication processors that support wired communication or wireless communication, which are operated independently of the processor 120 (e.g., an application processor). According to an embodiment, the communication module 190 includes a wireless communication module 192 (e.g., a cellular communication module, a near-field communication module, and/or a global navigation satellite system (GNSS) communication module) or a wired communication module 194 (e.g., a local area network (LAN) communication module and/or a power line communication module) and may communicate with an external electronic device through the first network 198 (e.g., a near-field communication module such as Bluetooth, WiFi direct, and/or infrared data association (IrDA)) or the second network 199 using a corresponding communication module. The various types of communication modules 190 described above may be implemented as a single chip or may be implemented as separate chips.

According to an embodiment, the wireless communication module 192 may use user information stored in the subscriber identity module 196 to identify and authenticate the electronic device 101 within a communication network.

The antenna module 197 may include one or more antennas for externally transmitting or receiving signals or power. According to an embodiment, the communication module 190 (e.g., the wireless communication module 192) may transmit or receive signals to or from an external electronic device via an antenna suitable for a communication method.

Some of the components may be connected to each other to exchange signals (e.g., commands or data) through a communication method (e.g., a bus, general purpose input/output (GPIO), a serial peripheral interface (SPI), and/or a mobile industry processor interface (MIPI)) between peripheral devices.

According to an embodiment, commands or data may be transmitted or received between the electronic device 101 and the external electronic device 104 through the server 108 connected to the second network 199. Each of the electronic devices 102 and 104 may be the same or a different kind of device as the electronic device 101. According to an embodiment, all or some of operations performed by the electronic device 101 may be performed in another external electronic device or a plurality of external electronic devices. According to an embodiment, when the electronic device 101 has to perform certain functions or services automatically or upon request, the electronic device 101 may request an external electronic device to execute at least some functions associated with the above functions or services instead of or in addition to executing the above functions or services itself. The external electronic device that has received the request may execute the requested function or additional function and transmit the result to the electronic device 101. The electronic device 101 may directly or additionally process the received result to provide the requested functions or services. For this purpose, for example, cloud computing, distributed computing, and/or client-server computing technology may be used.

According to an embodiment, the electronic device 101 may further include a cache memory, tightly coupled memory (TCM), or the like.

According to various embodiments, an electronic device (e.g., the electronic device 101) includes a memory (e.g., the memory 130) and a processor (e.g., the processor 120) operatively connected to the memory. The processor is configured to divide an image into a plurality of sub images, load information about a first sub image of the plurality of sub images into the memory, perform image processing on the first sub image, load information about an image area that does not overlap with the first sub image of a second sub image located in a longitudinal direction of the first sub image into the memory, and perform image processing on the second sub image.

According to various embodiments, the second sub image may be an image that is continuous with the first sub image.

According to various embodiments, the processor may be configured to perform image processing on a sub image by performing one of Gaussian filtering, Sobel filtering, or box filtering based on information about the sub image.

According to various embodiments, when the image processing on the first sub image is performed, the processor may be configured to store information about an image area that does not overlap with the second sub image of the first sub image in other memory different from the memory.

According to various embodiments, when the information about the image area that does not overlap with the second sub image of the first sub image is stored in the other memory, the processor may be configured to delete the information about the image area that does not overlap with the second sub image of the first sub image from the memory.

According to various embodiments, the processor may be configured to perform image processing on the second sub image by identifying information about an image area that overlaps with the second sub image of the first sub image and the information about an image area that does not overlap with the first sub image of the second sub image from the memory and by performing image filtering based on the identified information.

According to various embodiments, an electronic device (e.g., the electronic device 101) includes a memory (e.g., the memory 130) and a processor (e.g., the processor 120) operatively connected to the memory. The processor is configured to divide an image into a plurality of sub images, load information about a first sub image of the plurality of sub images into the memory, load information about an image area that does not overlap with the first sub image of a second sub image located in a horizontal direction of the first sub image into the memory, and perform image processing on the second sub image.

According to various embodiments, the second sub image may be an image that is continuous with the first sub image.

According to various embodiments, the processor may be configured to perform image processing on a sub image by performing one of Gaussian filtering, Sobel filtering, or box filtering based on information about the sub image.

According to various embodiments, when the image processing on the first sub image is performed, the processor may be configured to store information about an image area that does not overlap with the second sub image of the first sub image in other memory different from the memory.

According to various embodiments, when the information about the image area that does not overlap with the second sub image of the first sub image is stored in the other memory, the processor may be configured to delete the information about the image area that does not overlap with the second sub image of the first sub image from the memory.

According to various embodiments, the processor may be configured to perform image processing on the second sub image by identifying information about an image area that overlaps with the second sub image of the first sub image and the information about an image area that does not overlap with the first sub image of the second sub image from the memory and by performing image filtering based on the identified information.

According to various embodiments, an electronic device (e.g., the electronic device 101) includes a memory (e.g., the memory 130) and a processor (e.g., the processor 120) operatively connected to the memory. The processor is configured to divide an image into a plurality of sub images, load information about a first sub image of the plurality of sub images into the memory, perform image processing on the first sub image, load information about an image area that does not overlap with a second sub image of the second sub image located in a longitudinal direction of the first sub image into the memory, perform image processing on the second sub image, load information about an image area that does not overlap with the first sub image of a third sub image located in a horizontal direction of the first sub image into the memory, perform image processing on the third sub image, load information about an image area that does not overlap with adjacent sub images of a fourth sub image located in a horizontal direction of the second sub image into the memory, and perform image processing on the fourth sub image.

According to various embodiments, the processor may be configured to perform image processing on a sub image by performing one of Gaussian filtering, Sobel filtering, or box filtering based on information about the sub image.

According to various embodiments, when the image processing on the sub image is performed, the processor may be configured to store information about an image area that does not overlap with adjacent sub images of the sub image in another memory different from the memory.

According to various embodiments, the processor may be configured to perform image processing on the second sub image by identifying information about an image area that overlaps with the second sub image of the first sub image and the information about an image area that does not overlap with the first sub image of the second sub image from the memory and by performing image filtering based on the identified information.

According to various embodiments, the processor may be configured to perform image processing on the third sub image by identifying information about an image area that overlaps with the second sub image of the first sub image and the information about an image area that does not overlap with the first sub image of the second sub image from the memory and by performing image filtering based on the identified information.

According to various embodiments, the processor may be configured to perform image processing on the fourth sub image by identifying information about an area where the fourth sub image and other sub images overlap with each other and information about an image area that does not overlap with the adjacent sub images of the fourth sub image from the memory and by performing image filtering based on the identified information.

Electronic devices according to various embodiments disclosed herein may be various types of devices. The electronic device may include, for example, at least one of a portable communication device (e.g., a smart phone), a computer device, a portable multimedia device, a portable medical device, a camera, a wearable device, and/or a home appliance. The electronic device according to embodiments is not limited to the above-described devices.

However, this does not limit the inventive concepts to specific embodiments, and it should be understood that the inventive concepts cover all the modifications, equivalents and replacements included within the idea and technical scope of the inventive concepts. Similar reference numerals are assigned to similar elements throughout the specification. As used herein, the singular forms “a”, “an”, and “the” are intended to include the plural forms as well, unless the context clearly indicates otherwise. In the specification, the terms “A or B”, “at least one of A and/or B”, “A, B, or C”, “at least one of A, B, and/or C”, and the like may include all possible combinations of the items listed together. It will be understood that although the terms “first”, “second”, “third”, etc. may be used herein to describe various components, these components should not be limited by these terms. Further, if it is described that one element (e.g., first element) is “connected” or “accesses” the other element (e.g., second element), it is understood that the one element may be directly connected to or may directly access the other element but unless explicitly described to the contrary, another element (e.g., third element) may be “connected” or “access” between the elements.

The term “module” as used herein encompasses units comprised of hardware, software, or firmware and may be used interchangeably with terms such as logic, logic blocks, components, or circuits. The “module” may be an integrally constructed component or a minimum unit or part thereof that performs one or more functions. For example, the module may be configured as an application-specific integrated circuit (ASIC).

Various embodiments of the present document may be implemented in software (e.g., the program 140) including instructions stored in machine-readable storage media (e.g., an internal memory 136 or an external memory 138) readable by a machine (e.g., a computer). The machine may include an electronic device (e.g., the electronic device 101) according to the disclosed embodiments as a device capable of calling stored instructions from the storage media and operating according to the called instructions. When the instructions are executed by a processor (e.g., the processor 120), the processor may perform functions corresponding to the instructions, either directly or under the control of the processor, using other components. The instructions may include a code generated or executed by a compiler or an interpreter. The computer-readable storage media may be provided in the form of a non-transitory storage medium. Here, the term ‘non-transitory’ means that a storage medium does not include a signal and is tangible, and does not distinguish whether data is stored in the storage medium semi-permanently or temporarily.

According to an embodiment, methods according to various embodiments of the specification may be provided by being included in a computer program product. The computer program product is a product that may be traded between a seller and a purchaser. A computer program product may be distributed in the form of a machine-readable storage medium (e.g., compact disc read only memory (CD-ROM)) or distributed online through an application store (e.g., PlayStoreTM). In the case of on-line distribution, at least a portion of the computer program product may be temporarily stored, or temporarily created, on a storage medium such as a manufacturer's server, a server of an application store, or a memory of a relay server.

Each of components (e.g., modules or programs) according to various embodiments may be comprised of a single entity or a plurality of entities, and some of the subcomponents described above may be omitted, or other subcomponents may be further included in the various embodiments. Alternatively or additionally, some of the components (e.g., modules or programs) may be integrated into one entity to perform the same or similar functions performed by respective corresponding components prior to integration. Operations performed by modules, program modules, or other components, according to various embodiments, may be performed sequentially, in parallel, repetitively, or heuristically, or at least some of the operations may be performed in a different order, omitted, or other operations may be added.

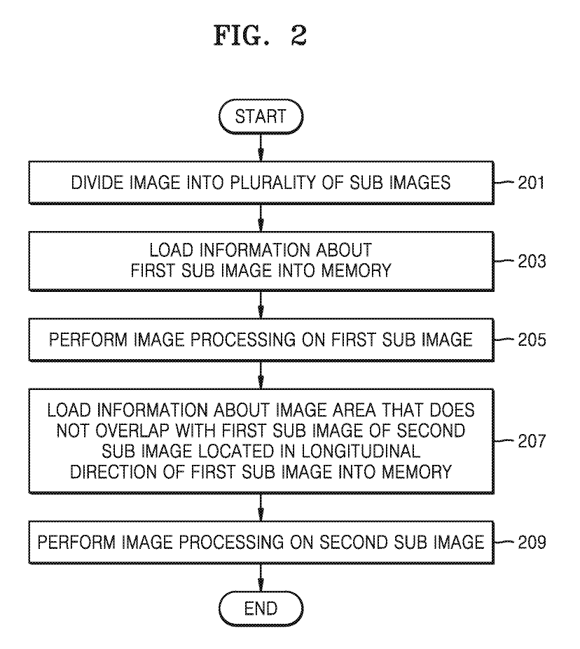

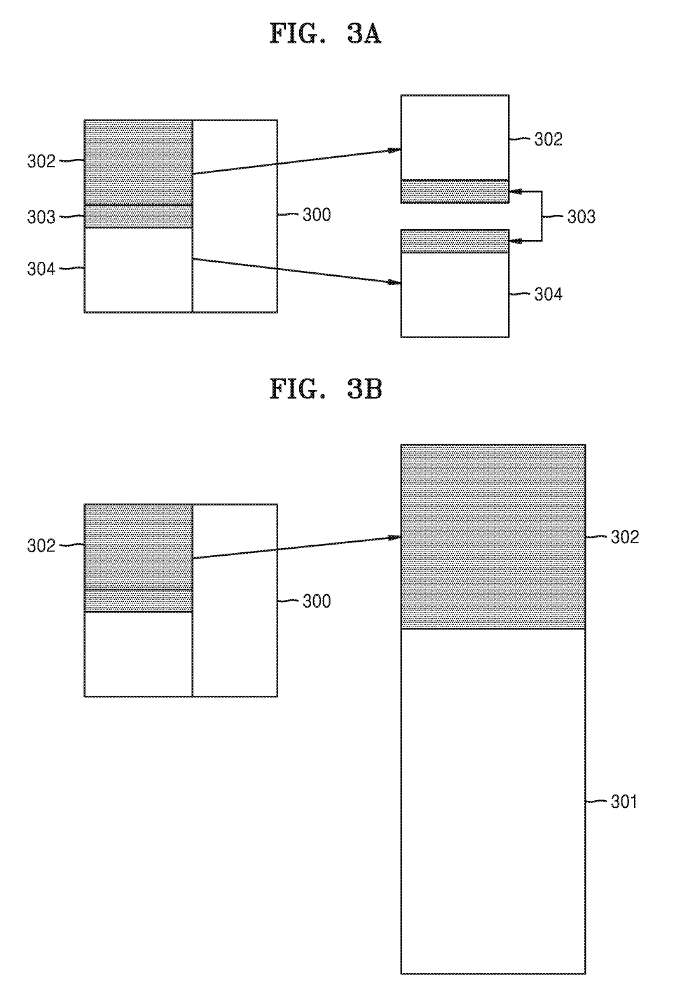

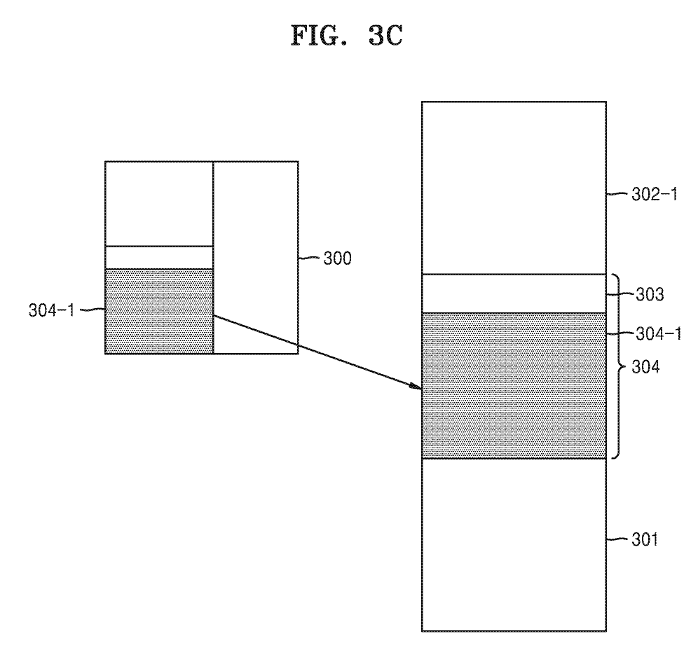

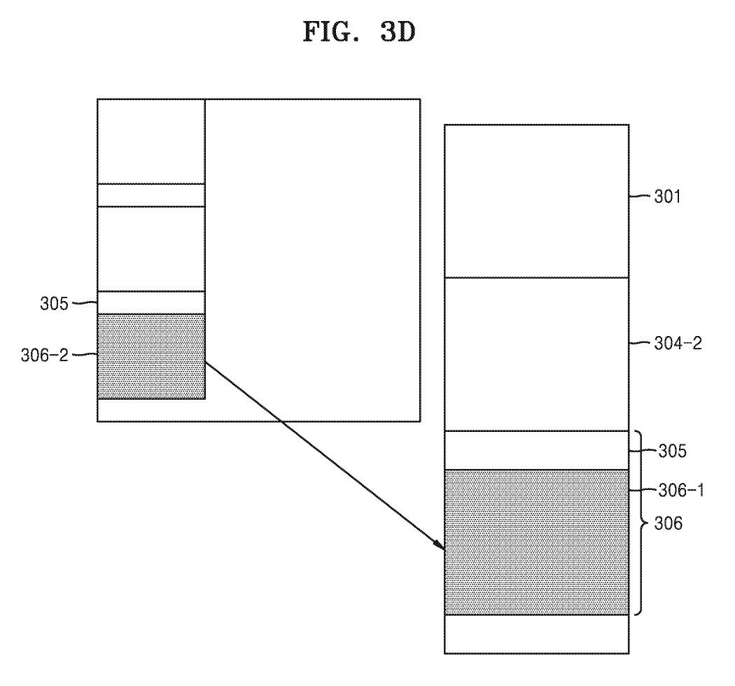

FIG. 2 is a flowchart for explaining an example of a method of processing images in an electronic device according to various embodiments. FIGS. 3A to 3D are views for explaining an example of a method of processing images in an electronic device according to various embodiments.

Referring to FIG. 2, in operation 201, a processor (e.g., the processor 120) of an electronic device (e.g., the electronic device 101) may divide an image into a plurality of sub images. Here, each of the sub images may be partially overlapped with adjacent sub images. For example, as shown in FIG. 3A, a first sub image 302 in an image 300 and a second sub image 304 located below the first sub image 302 may overlap in a partial area 303 and be images that are continuous in a longitudinal direction.

In operation 203, the processor may load information about the first sub image into a memory 301. For example, the processor may load information about the first sub image 302 into the memory 301 in the image 300, as shown in FIG. 3B. The memory 301 may include a cache memory, a tightly coupled memory (TCM), or the like.

In operation 205, the processor may perform image processing on the first sub image 302. For example, the processor may perform image filtering based on information about the first sub image 302 loaded into the memory 301. According to an embodiment, the image filtering may include Gaussian filtering, Sobel filtering, box filtering, or the like. When the image filtering is completed, the processor may store information about an image area 302-1 that does not overlap with the second sub-image of the first sub image in another memory (e.g., the memory 130). For example, when the image processing (e.g., image filtering) on the first sub image is completed, the processor may identify information about the image area 302-1 that does not overlap with the second sub image of the first sub image from the memory 301, as shown in FIG. 3C. The processor may store the identified information about the image area 302-1 in another memory. According to an embodiment, the processor may store the identified information about the image area 302-1 in other memory and then delete the information from the memory 301.

In operation 207, the processor may load information about an image area that does not overlap with the first sub image of the second sub image located in a longitudinal direction of the first sub image into the memory. For example, the processor may load information about an image area 304-1 that does not overlap with the first sub image of the second sub image 304 in the image 300 into the memory 301, as shown in FIG. 3C. According to an embodiment, operation 207 may be performed in parallel with operation 205. For example, the processor may perform image processing on the first sub image and simultaneously load information about an image area that does not overlap with the first sub image of the second sub image into the memory.

In operation 209, the processor may perform image processing on the second sub image 304. For example, as shown in FIG. 3C, the processor may identify information about the second sub image 304 based on information about the image area 303 in which the first sub image and the second sub image loaded into the memory 301 overlap with each other and information about the image area 304-1 that does not overlap with the first sub image of the second sub image. The processor may perform image filtering based on the identified information about the second sub image 304. The processor may store information about the second sub image 304 on which image processing has been performed in another memory.

As described above, when performing image processing on a plurality of sub images, the electronic device of the inventive concepts may reduce the amount of data transmission by loading only information about the remaining area excluding information about overlapping image area into a memory and performing image processing. As a result, the electronic device may shorten an image processing time and/or reduce power consumption.

In the above description, the image processing is performed on two sub images located in a longitudinal direction. However, according to the various embodiments of the inventive concepts, the electronic device may perform image processing on three or more sub images located in the longitudinal direction in the same manner. For example, when there is an additional sub image 306 to perform image processing as shown in FIG. 3D, in operation 209, the processor of the electronic device may store only information about an image area 304-2 that does not overlap with the additional sub image 306 of the second sub image in another memory. The processor may load information about an image area 306-2 that does not overlap with the second sub image of the additional sub image 306 into the memory 301. The processor may identify information about the additional sub image 306 based on information about an image area 305 in which the second sub image and the additional sub image overlap with each other and information about an image area 306-1 that does not overlap with the second sub image of the additional sub image 306. The processor may perform image processing (image filtering) on the additional sub image based on the identified information about the additional sub image. As such, the electronic device of the inventive concepts, when information about an image area that does not overlap with a previous sub image of an additional sub image is stored in a memory, may ensure memory coherence by storing the information at a position consecutive to a position where information about an image area that overlaps with the previous sub image is stored.

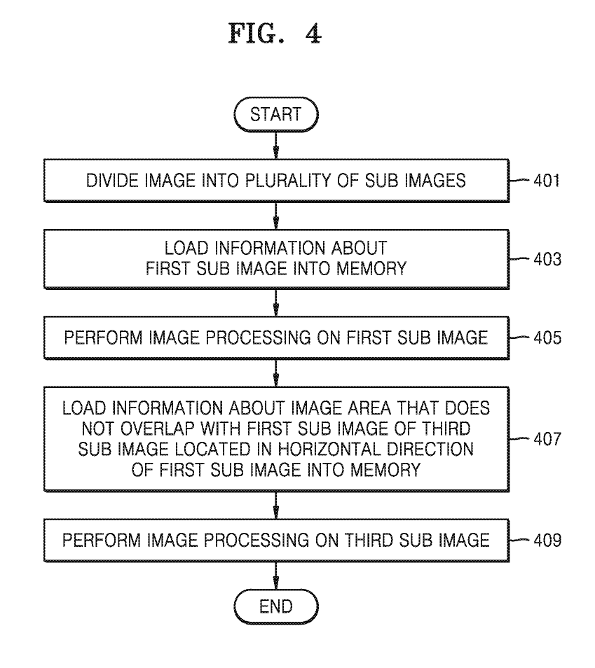

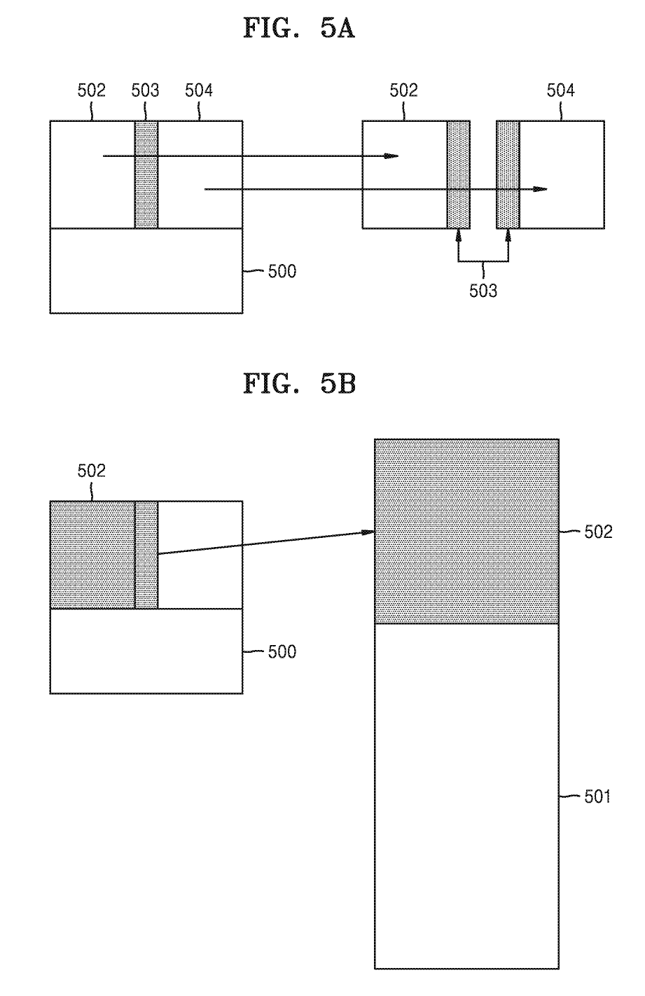

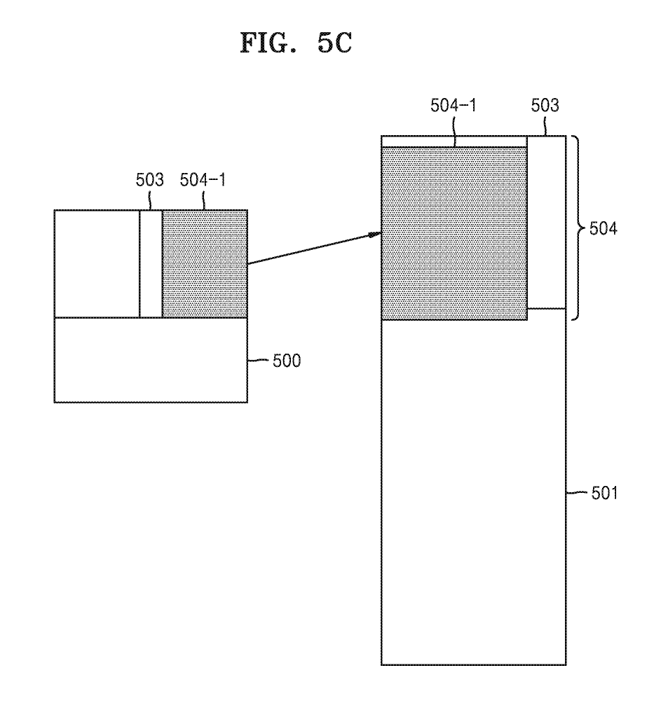

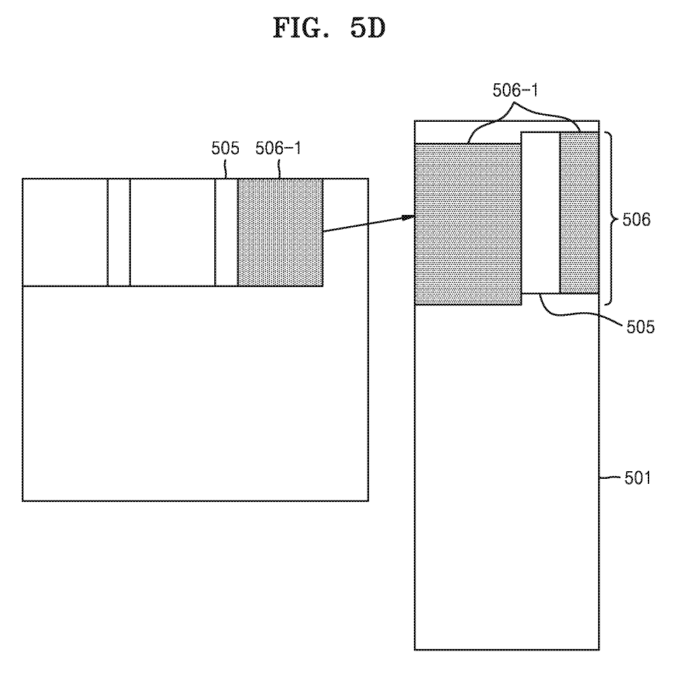

FIG. 4 is a flowchart for explaining an example of a method of processing images in an electronic device according to various embodiments. FIGS. 5A to 5D are views for explaining an example of a method of processing an image in an electronic device according to various embodiments.

Referring to FIG. 4, in operation 401, a processor (e.g., the processor 120) of an electronic device (e.g., the electronic device 101) may divide an image into a plurality of sub images. Here, each of the sub images may be partially overlapped with adjacent sub images. For example, as shown in FIG. 5A, a first sub image 502 in an image 500 and a third sub image 504 located in a horizontal direction of the first sub image 502 may overlap in a partial area 503 and be images that are continuous in a longitudinal direction.

In operation 403, the processor may load information about the first sub image into a memory. For example, the processor may determine a start address of the information about the first sub image to be loaded into the memory using Equation 1 below.

```
[Equation 1]
if (n <= 2)
    LdAₙ = StartAddrᵢₘ + (N − 1) * strideᵢₘ
else
  LdAₙ = StartAddrᵢₘ + (N − 1) * strideᵢₘ − (N − 2) * psize
```

In Equation 1, LdA denotes a start address of information about a sub image to be stored in a memory, StartAddrᵢₘ denotes a start address of the memory, strideᵢₘ denotes a width of the sub image, and psize denotes a width of an overlapping area between sub images. According to Equation 1, a start address of the first sub image may be determined as the start address of the memory. The processor, when the start address of the first sub image is determined, may load the information about the first sub image into the memory based on the determined start address. For example, as shown in FIG. 5B, the processor may load information about the first sub image 502 in the image 500 into the memory from a start address of a memory 501. Here, the memory 501 may include a cache memory, TCM, or the like.

In operation 405, the processor may perform image processing on the first sub image. For example, the processor may determine a start address of the information about the first sub image to perform image processing from the memory using Equation 2 below.

```
[Equation 2]
if (n == 1)
  ExAₙ = StartAddrᵢₘ
else
  ExAₙ = StartAddrᵢₘ + (N − 1) * strideᵢₘ − (N − 1) * psize
```

In Equation 2, ExA denotes a start address of information about a sub image to perform image processing, strideᵢₘ denotes a width of the sub image, and psize denotes a width of an overlapping area between sub images. The processor may identify the information about the first sub image from the memory based on the start address of the first sub image confirmed using Equation 2. The processor may perform image filtering, such as Gaussian filtering, Sobel filtering, or box filtering, based on the identified information about the first sub image. However, an image filtering method is not limited thereto. When the image filtering is completed, the processor may store information about an image area that does not overlap with the third sub image of the first sub image in other memory (e.g., the memory 130). According to an embodiment, the processor may store the information about an image area that does not overlap with the third sub image of the first sub image in other memory and then delete the information from the memory.

In operation 407, the processor may load information about an image area that does not overlap with the first sub image of the third sub image located in a horizontal direction of the first sub image into the memory. For example, the processor may determine the image area that does not overlap with the first sub image of the third sub image by Equation 3 below.

```
[Equation 3]
Tile_width = Tile_width_{origin}
Tile_height = Tile_height_{origin}
if( tile is at left board)
  actual internal tile width = Tile_width_{origin}
else
  actual internal tile width = Tile_width_{origin} − neighbor
```

In Equation 3, Tile_width denotes a width (a specified value) of a sub image, Tile_height denotes a height (a specified value) of the sub image, and neighbor denotes a width of an overlapping area between sub images. That is, as shown in Equation 3, the processor may determine an image area that does not overlap with the first sub image of the third sub image by determining a value obtained by subtracting a width of an image area that overlaps with the first sub image from a width of the third sub image as a width value of an image area to be loaded into the memory and by determining a height value of a specified sub image as a height value of the image area to be loaded into the memory. The processor may determine a start address of an image area determined using Equation 1 when determining the image area that does not overlap with the first sub image of the third sub image by Equation 3 below. The processor may load the determined image area into the memory according to the determined start address. For example, as shown in FIG. 5C, the processor may load information about a determined image area 504-1 into the memory 501. As information is loaded into the memory using Equation 1, information about the image area 504-1 loaded into the memory may be located in a space of the memory 301 continuous to information about an area 503 in which the first sub image and the third sub image overlap with each other.

In operation 409, the processor may perform image processing on the third sub image. For example, as shown in FIG. 5C, the processor may identify the information about the third sub image 504 based on information about the image area 503 in which the first sub image and the third sub image loaded into the memory 501 overlap with each other and information about the image area 504-1 that does not overlap with the first sub image of the third sub image. The processor may perform image filtering based on the identified information about the third sub image 504. The processor may store information about the third sub image 504 on which image processing has been performed in other memory.

As described above, when performing image processing on a plurality of sub images, the electronic device of the inventive concepts may reduce the amount of data transmission by loading only information about the remaining area excluding information about overlapping image area into a memory and performing image processing. As a result, the electronic device may shorten an image processing time and/or reduce power consumption.

In the above description, the image processing is performed on two sub images located in a longitudinal direction. However, according to the various embodiments of the inventive concepts, the electronic device may perform image processing on three or more sub images located in the horizontal direction in the same manner. For example, when there is an additional sub image 506 to perform image processing as shown in FIG. 5D, in operation 409, the processor of the electronic device may store only information about an image area that does not overlap with the additional sub image 506 of the third sub image in other memory. The processor may load information about an image area 506-1 that does not overlap with the third sub image of the additional sub image 506 into the memory 301. The processor may identify information about the additional sub image 506 based on information about an image area 505 in which the third sub image and the additional sub image 506 loaded into the memory 301 overlap with each other and information about an image area 506-1 that does not overlap with the third sub image of the additional sub image 506. The processor may perform image processing (image filtering) on the additional sub image based on the identified information about the additional sub image 506.

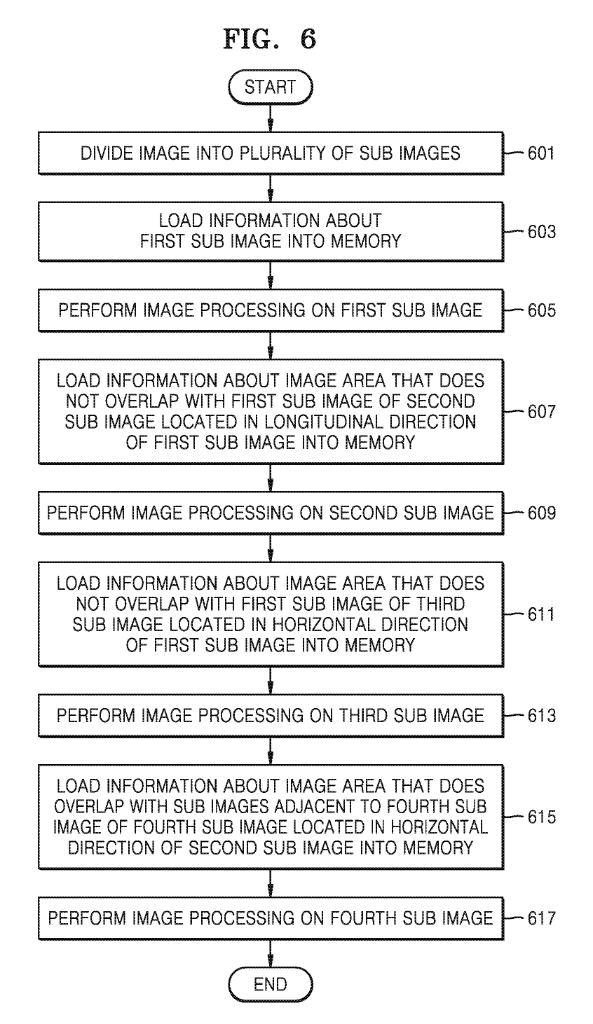

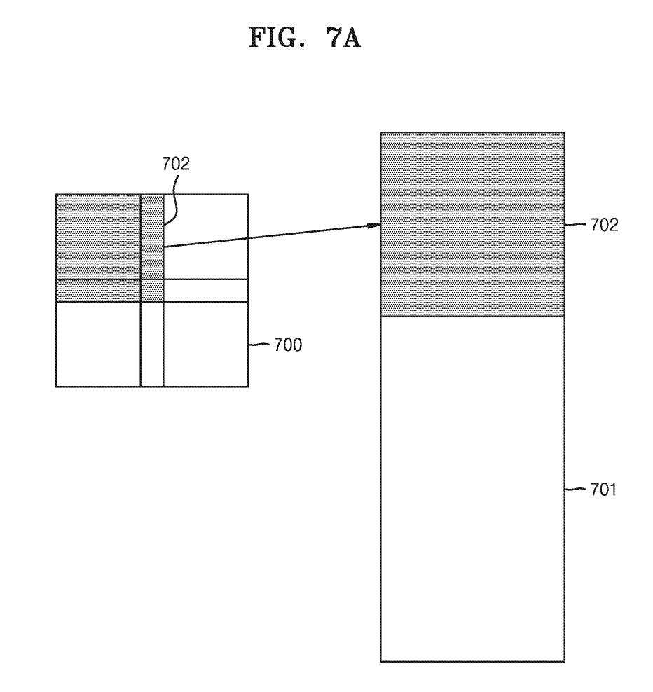

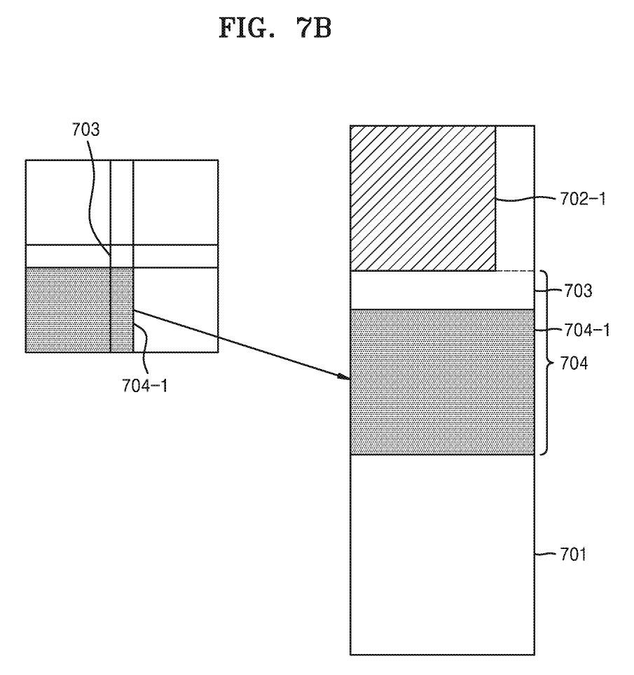

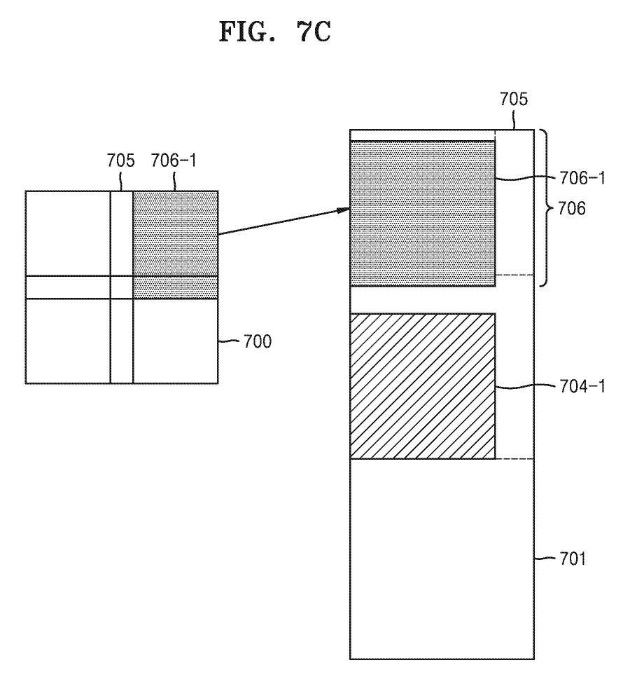

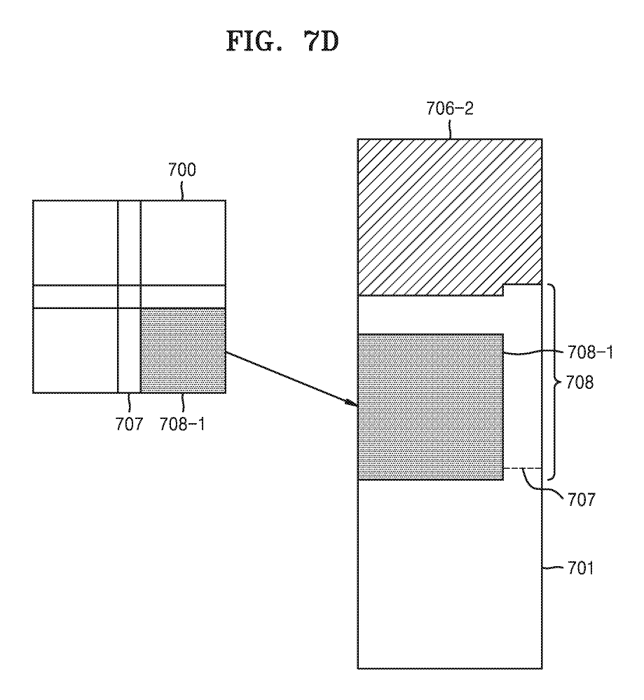

FIG. 6 is a flowchart for explaining an example of a method of processing images in an electronic device according to various embodiments. FIGS. 7A to 7D are views for explaining an example of a method of processing images in an electronic device according to various embodiments.

Referring to FIG. 6A, in operation 601, a processor (e.g., the processor 120) of an electronic device (e.g., the electronic device 101) may divide an image into a plurality of sub images. Here, each of the sub images may be partially overlapped with adjacent sub images.

In operation 603, the processor may load information about a first sub image 702 into a memory. For example, the processor may load information about the first sub image 702 in an image 700 into a memory 701, as shown in FIG. 7A. Here, the memory 701 may include a cache memory, TCM, or the like.

In operation 605, the processor may perform image processing on the first sub image 702. For example, the processor may perform image filtering, such as Gaussian filtering, Sobel filtering, or box filtering, based on the information about the first sub image loaded into the memory 701. When the image filtering is completed, as shown in FIG. 7B, the processor may store information about an area 702-1 that does not overlap with sub images adjacent to the first sub image of the first sub image in other memory (e.g., the memory 130). According to an embodiment, the processor may store the information about the area 702-1 that does not overlap with sub images adjacent to the first sub image of the first sub image in other memory and then delete the information from the memory 701.

In operation 607, the processor may load information about an image area that does not overlap with the first sub image of the second sub image located in a longitudinal direction of the first sub image into the memory 701. For example, the processor may load information about an image area 704-1 that does not overlap with the first sub image of the second sub image 304 into the memory 701, as shown in FIG. 7B. According to an embodiment, the processor may perform operation 605 for performing image processing on the first sub image and operation 607 for loading information about an image area that does not overlap with the first sub image of the second sub image located in a longitudinal direction of the first sub image into the memory 701, in parallel.

In operation 609, the processor may perform image processing on the second sub image. For example, as shown in FIG. 7B, the processor may identify the second sub image 704 based on information about an image area 703 in which the first sub image and the second sub image loaded into the memory 701 overlap with each other and information about the image area 704-1 that does not overlap with the first sub image of the second sub image. The processor may perform image filtering based on the identified information about the second sub image 704. After completing the image filtering, as shown in FIG. 7C, the processor may store the information about the area 702-1 that does not overlap with sub images adjacent to the second sub image of the second sub image in another memory. According to an embodiment, the processor may store the information about the area 704-1 that overlaps with sub images adjacent to the second sub image of the second sub image in another memory and then delete the information from the memory 701.

In operation 611, the processor may load information about an image area that does not overlap with the first sub image of the third sub image located in a horizontal direction of the first sub image into the memory 701. For example, the processor may determine an image area 706-1 that does not overlap with the first sub image of the third sub image, as shown in FIG. 7C. The processor, when the image area 706-1 that does not overlap with the first sub image of the third sub image is determined, may determine a start address of the determined image area 706-1. The processor, when the start address is determined, may load the determined image area 706-1 into the memory 701 based on the determined start address.

In operation 613, the processor may perform image processing on the third sub image. For example, the processor may determine a start address of the information about the third sub image to perform image processing from the memory 701. The processor may identify information about a third sub image 706 from the memory 701, based on the determined start address, as shown in FIG. 7C. The processor may perform image filtering (e.g., Gaussian filtering, Sobel filtering, or box filtering, etc.) based on the identified information about the third sub image 706. When the image filtering is completed, as shown in FIG. 7D, the processor may store information about an area 706-2 that does not overlap with sub images adjacent to the third sub image of the third sub image in other memory. According to an embodiment, when the information about the area 706-2 that does not overlap with sub images adjacent to the third sub image of the third sub image is stored in other memory, the processor may delete the information from the memory 701.

In operation 615, the processor may load information about an image area that does not overlap with sub images adjacent to the fourth sub image of the fourth sub image located in a horizontal direction of the second sub image into the memory 701. For example, the processor may determine an image area 708-1 that does not overlap with sub images (e.g., the first sub image to the third sub image) adjacent to the fourth sub image of the fourth sub image, as shown in FIG. 7D. The processor, when the image area 708-1 that does not overlap with the fourth sub image adjacent to the fourth sub image of the fourth sub image is determined, may determine a start address of the determined image area 708-1. The processor may load the determined image area 708-1 into the memory 701 based on the determined start address.

In operation 617, the processor may perform image processing on the fourth sub image. For example, the processor may determine a start address of the information about the fourth sub image to perform image processing from the memory 701. The processor may identify information about a fourth sub image 708 from the memory 701, based on the determined start address, as shown in FIG. 7D. The processor may perform image filtering based on the identified information about the fourth sub image 708. When the image filtering is completed, the processor may store the information about the fourth sub image 708 in another memory. According to an embodiment, when the information about the fourth sub image 708 is stored in another memory, the processor may delete the information from the memory 701.

As described above, when performing image processing on a plurality of sub images, the electronic device of the inventive concepts may reduce the amount of data transmission by loading only information about the remaining area excluding information about overlapping image area into a memory and performing image processing. For example, when image processing is performed through a Gaussian 7×7 filter and the size of a sub image is 64×64, the electronic device of the inventive concepts may reduce the transfer rate of data loaded into a memory as compared with a conventional method of not reusing an overlapping image area as shown in Table 1 below. As a result, the electronic device may shorten an image processing time and/or reduce power consumption.

TABLE 1

| | Transfer rate of data loaded | Transfer rate of data loaded |
|---|---|---|
| | into a memory | into a memory |
| Size of image | in conventional method | in the present disclosure |
| FHD(RGB) | 125.10% | 104.53% |
| QHD(RGB) | 123.15% | 104.37% |
| UHD(RGB) | 124.48% | 104.53% |

The method of processing an image in the case where the image is divided into four sub images has been described above. However, according to various embodiments of the inventive concepts, the electronic device may be divided into more than four sub images, and the divided sub images may be used for image processing by loading only information about the remaining area except for an overlapping image area into a memory like the operations of FIG. 6.

According to various embodiments, a method of operating an electronic device (e.g., the electronic device 101) may include dividing an image into a plurality of sub images, loading information about a first sub image of the plurality of sub images into a memory (e.g., the memory 130) of the electronic device, performing image processing on the first sub image, loading information about an image area that does not overlap with the first sub image of a second sub image located in a longitudinal direction of the first sub image into the memory, and performing image processing on the second sub image.

According to various embodiments, the second sub image may be an image that is continuous with the first sub image.

According to various embodiments, the performing of image processing on the first sub image or the second sub image may include performing one of Gaussian filtering, Sobel filtering, and box filtering based on information about the first sub image or the second sub image.

According to various embodiments, when the image processing on the first sub image is performed, the method of operating the electronic device may further include storing information about an image area that does not overlap with the second sub image of the first sub image in a memory different from the memory.

According to various embodiments, when the information about the image area that does not overlap with the second sub image of the first sub image is stored in the other memory, the processor may further include deleting information about the image area that does not overlap with the second sub image of the first sub image from the memory.

According to various embodiments, the performing of image processing on the second sub image may include identifying information about an image area that overlaps with the second sub image of the first sub image and information about an image area that does not overlap with the first sub image of the second sub image from the memory, and performing image filtering based on the identified information.

According to various embodiments, a method of operating an electronic device (e.g., the electronic device 101) may include dividing an image into a plurality of sub images, loading information about a first sub image of the plurality of sub images into a memory (e.g., the memory 130) of the electronic device, loading information about an image area that does not overlap with the first sub image of a second sub image located in a horizontal direction of the first sub image into the memory, and performing image processing on the second sub image.

According to various embodiments, the second sub image may be an image that is continuous with the first sub image.

According to various embodiments, the performing of image processing on the first sub image or the second sub image may include performing one of Gaussian filtering, Sobel filtering, and box filtering based on information about the first sub image or the second sub image.

According to various embodiments, when the image processing on the first sub image is performed, the method of operating the electronic device may further include storing information about an image area that does not overlap with the second sub image of the first sub image in a memory different from the memory.

According to various embodiments, when the information about the image area that does not overlap with the second sub image of the first sub image is stored in the other memory, the processor may further include deleting information about the image area that does not overlap with the second sub image of the first sub image from the memory.

According to various embodiments, the performing of image processing on the second sub image may include identifying information about an image area that overlaps with the second sub image of the first sub image and information about an image area that does not overlap with the first sub image of the second sub image from the memory, and performing image filtering based on the identified information.

According to various embodiments, an electronic device (e.g., the electronic device 101) may include dividing an image into a plurality of sub images, loading information about a first sub image of the plurality of sub images into a memory of the electronic device, performing image processing on the first sub image, loading information about an image area that does not overlap with a second sub image of the second sub image located in a longitudinal direction of the first sub image into the memory, performing image processing on the second sub image, loading information about an image area that does not overlap with the first sub image of a third sub image located in a horizontal direction of the first sub image into the memory, performing image processing on the third sub image, loading information about an image area that does not overlap with adjacent sub images of a fourth sub image located in a horizontal direction of the second sub image into the memory, and performing image processing on the fourth sub image.

According to various embodiments, the performing of image processing on the first sub image or the second sub image may include performing one of Gaussian filtering, Sobel filtering, and box filtering based on information about the first sub image or the second sub image.

According to various embodiments, when the image processing on the sub images is performed, the method of operating the electronic device may further include storing information about an image area that does not overlap with adjacent sub images of the sub images in a memory different from the memory.

According to various embodiments, the performing of image processing on the second sub image may include identifying information about an image area that overlaps with the second sub image of the first sub image and information about an image area that does not overlap with the first sub image of the second sub image from the memory, and performing image filtering based on the identified information.

According to various embodiments, the performing of image processing on the third image may include identifying information about an image area that overlaps with the second sub image of the first sub image and information about an image area that does not overlap with the first sub image of the second sub image from the memory, and performing image filtering based on the identified information.

According to various embodiments, the performing of image processing on the fourth sub image may include identifying information about an area where the fourth sub image and other sub images overlap with each other and information about an image area that does not overlap with sub images adjacent to the fourth sub image of the fourth sub image from the memory, and performing image filtering based on the identified information.

While the inventive concepts have been particularly shown and described with reference to embodiments thereof, it will be understood that various changes in form and details may be made therein without departing from the spirit and scope of the following claims.

What is claimed is:

1. An electronic device comprising:
a memory; and
a processor operatively connected to the memory,
wherein the processor is configured to:
divide an image into a plurality of sub images;
load information about a first sub image of the plurality of sub images into the memory;
perform image processing on the first sub image;
load information about an image area that does not overlap with the first sub image of a second sub image located in a longitudinal direction of the first sub image into the memory; and
perform image processing on the second sub image.

2. The electronic device of claim 1, wherein the second sub image is an image that is continuous with the first sub image.

3. The electronic device of claim 1, wherein the processor is configured to perform image processing on a sub image by performing one of Gaussian filtering, Sobel filtering, or box filtering based on information about the sub image.

4. The electronic device of claim 1, wherein the processor, when the image processing on the first sub image is performed, is configured to store information about an image area that does not overlap with the second sub image of the first sub image in another memory different from the memory.

5. The electronic device of claim 4, wherein the processor, when the information about the image area that does not overlap with the second sub image of the first sub image is stored in the another memory, is configured to delete the information about the image area that does not overlap with the second sub image of the first sub image from the memory.

6. The electronic device of claim 1, wherein the processor is configured to:
identify information about an image area that overlaps with the second sub image of the first sub image and information about an image area that does not overlap with the first sub image of the second sub image from the memory; and
perform image processing on the second sub image by performing image filtering based on the identified informations.

7. An electronic device comprising:
a memory; and
a processor operatively connected to the memory,
wherein the processor is configured to:
divide an image into a plurality of sub images;
load information about a first sub image of the plurality of sub images into the memory;
load information about an image area that does not overlap with the first sub image of a second sub image located in a horizontal direction of the first sub image into the memory; and
perform image processing on the second sub image.

8. The electronic device of claim 7, wherein the second sub image is an image that is continuous with the first sub image.

9. The electronic device of claim 7, wherein the processor is configured to perform image processing on a sub image by performing one of Gaussian filtering, Sobel filtering, or box filtering based on information about the sub image.

10. The electronic device of claim 7, wherein the processor, when the image processing on the first sub image is performed, is configured to store information about an image area that does not overlap with the second sub image of the first sub image in another memory different from the memory.

11. The electronic device of claim 10, wherein the processor, when the information about the image area that does not overlap with the second sub image of the first sub image is stored in the another memory, is configured to delete the information about the image area that does not overlap with the second sub image of the first sub image from the memory.

12. The electronic device of claim 7, wherein the processor is configured to:
identify information about an image area that overlaps with the second sub image of the first sub image and information about an image area that does not overlap with the first sub image of the second sub image from the memory; and
perform image processing on the second sub image by performing image filtering based on the identified informations.

13. An electronic device comprising:
a memory; and
a processor operatively connected to the memory,
wherein the processor is configured to:
divide an image into a plurality of sub images;
load information about a first sub image of the plurality of sub images into the memory;
perform image processing on the first sub image;
load information about an image area that does not overlap with a second sub image of the second sub image located in a longitudinal direction of the first sub image into the memory;
perform image processing on the second sub image;
load information about an image area that does not overlap with the first sub image of a third sub image located in a horizontal direction of the first sub image into the memory;
perform image processing on the third sub image;
load information about an image area that does not overlap with adjacent sub images of a fourth sub image located in a horizontal direction of the second sub image into the memory; and
performing image processing on the fourth sub image.

14. The electronic device of claim 13, wherein the processor is configured to perform image processing on a sub image by performing one of Gaussian filtering, Sobel filtering, or box filtering based on information about the sub image.

15. The electronic device of claim 13, wherein the processor, when the image processing on a sub image is performed, is configured to store information about an image area that does not overlap with adjacent sub images of the sub image in another memory different from the memory.

16. The electronic device of claim 13, wherein the processor is configured to:
identify information about an image area that overlaps with the second sub image of the first sub image and information about an image area that does not overlap with the first sub image of the second sub image from the memory; and
perform image processing on the second sub image by performing image filtering based on the identified informations.

17. The electronic device of claim 13, wherein the processor is configured to:
identify information about an image area that overlaps with the second sub image of the first sub image and information about an image area that does not overlap with the first sub image of the second sub image from the memory; and
perform image processing on the third sub image by performing image filtering based on the identified informations.

18. The electronic device of claim 13, wherein the processor is configured to:
identify information about an area where the fourth sub image and other sub images 1overlap with each other and information about an image area that does not overlap with the adjacent sub images of the fourth sub image from the memory; and
perform image processing on the fourth sub image by performing image filtering based on the identified informations.
